(19) United States
(12) Patent Application Publication
(10) Pub. No.: US 2026/0044731 A1
(43) Pub. Date: Feb. 12, 2026

(54) SYSTEMS AND METHODS FOR MATCHING INDIVIDUALS AND/OR TRAINING A PAIRING ALGORITHM BASED ON THIRD PARTY INPUT

(71) Applicants: Ahmed Farouk SHAABAN, South Barrington, IL (US); Venkat THANDRA, South Barrington, IL (US); Benjamin YEE, Lake Orion, MI (US)

(72) Inventors: Ahmed Farouk SHAABAN, South Barrington, IL (US); Venkat THANDRA, South Barrington, IL (US); Benjamin YEE, Lake Orion, MI (US)

(21) Appl. No.: 19/294,206

(22) Filed: Aug. 7, 2025

Related U.S. Application Data
(60) Provisional application No. 63/681,734, filed on Aug. 9, 2024.

(51) Int. Cl. G06N 3/08; G06F 16/9535; G06F 16/9538

(52) U.S. Cl. CPC G06N 3/08; G06F 16/9535; G06F 16/9538

(57) ABSTRACT

Systems and methods for matching individuals with each other are disclosed herein. In an embodiment, a method of matching individuals with each other includes creating a profile pair using a plurality of inputs from a first user regarding input characteristic preferences and the plurality of inputs from second user regarding input characteristics, receiving positive or negative selections regarding the profile pair from a plurality of third party users, training the pairing algorithm using the positive or negative selections, and using the trained pairing algorithm to reduce the plurality of pairs in the database.

### RELATED APPLICATION

This application claims priority to U.S. Provisional Application No. 63/681,734, filed Aug. 9, 2024 and entitled “Systems and Methods for Matching Individuals and/or Training a Pairing Algorithm Based on Third Party Input,” the entire contents of which is incorporated herein by reference and relied upon.

### BACKGROUND

### Technical Field

The present disclosure generally relates to systems and methods for pairing individuals and/or training a pairing algorithm based on third party input. More specifically, the present disclosure generally relates to systems and methods for pairing individuals with other individuals and/or training an algorithm to pair individuals with each other based on the third party input.

### Background Information

Digital platforms and applications have changed the way that individuals connect with each other. Various existing platforms and applications facilitate connections between individuals based on various algorithms and user preferences. Challenges remain in optimizing user matching, reducing storage space and processing resources, enhancing the user experience, and ensuring privacy and security.

### SUMMARY

The present disclosure provides improved systems and methods for pairing individuals with each other and/or training an algorithm to pair individuals with each other based on third party input. The disclosed systems and methods are particularly advantageous in creating compatible pairs while reducing processing resources and memory storage needed through intelligent data deletions.

A first aspect of the present disclosure is to provide computer-implemented method of training a neural network to create compatible pairs of user profiles using third party input. The method includes collecting third party input regarding whether a plurality of pairs of profiles displayed to a plurality of third party users are compatible or not compatible, creating a first training set comprising input data and preferences relating to each of the matched pair of profiles when the matched pair of profiles are determined to be a positive match, training the neural network in a first stage using the first training set, creating a second training set comprising input data and preferences relating to each of the matched pair of profiles when the matched pair of profiles are determined to be a negative match, and training the neural network in a second stage using the second training set.

A second aspect of the present disclosure is to provide system for pairing individuals with each other. The system includes a first user terminal, a second user terminal, and a central server having a memory and a processor. The first user terminal is configured to receive a plurality of inputs from a first user regarding input characteristic preferences. The second user terminal is configured to receive a plurality of inputs from a second user regarding input characteristics. The memory stores a database of a plurality of profile pairs and a pairing algorithm for creating the pairs of profiles. The processor is programmed to execute instructions stored on the memory so as to: (i) create a profile pair using the plurality of inputs from the first user regarding the input characteristic preferences and the plurality of inputs from the second user regarding the input characteristics; (ii) receive positive or negative selections regarding the profile pair from a plurality of third party users; (iii) train the pairing algorithm using the positive or negative selections; and (iv) use the trained pairing algorithm to reduce the plurality of pairs in the database.

A third aspect of the present disclosure is to provide a method of pairing individuals with each other. The method includes creating a profile pair using a plurality of inputs from a first user regarding input characteristic preferences and the plurality of inputs from second user regarding input characteristics, receiving positive or negative selections regarding the profile pair from a plurality of third party users, training the pairing algorithm using the positive or negative selections, and using the trained pairing algorithm to reduce the plurality of pairs in the database.

Other objects, features, aspects and advantages of the systems and methods disclosed herein will become apparent to those skilled in the art from the following detailed description, which, taken in conjunction with the annexed drawings, discloses exemplary embodiments of the disclosed systems and methods.

### BRIEF DESCRIPTION OF THE DRAWINGS

Referring now to the attached drawings which form a part of this original disclosure:

FIG. 1 illustrates an example embodiment of a system for pairing individuals with each other and/or training an algorithm to pair individuals with each other based on third party input in accordance with the present disclosure;

FIG. 2 illustrates an example embodiment of a system for pairing individuals with each other and/or training an algorithm to pair individuals with each other based on third party input in accordance with the present disclosure;

FIG. 3 illustrates an example embodiment of a user terminal which can be used in the system of FIGS. 1 and 2;

FIG. 4 illustrates an example embodiment of a method of using the system of FIGS. 1 and 2 to create and/or and continuously update a database in accordance with the present disclosure;

FIG. 5 illustrates an example embodiment of a method of using the system of FIGS. 1 and 2 and the database created using the method of FIG. 3 to pair individuals with each other based on third party input and/or train an algorithm to pair individuals with each other based on third party input in accordance with the present disclosure; and

FIG. 6 illustrates an example code snippet for adjusting the speed at which notifications are provided to users in accordance with an embodiment of the present disclosure.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

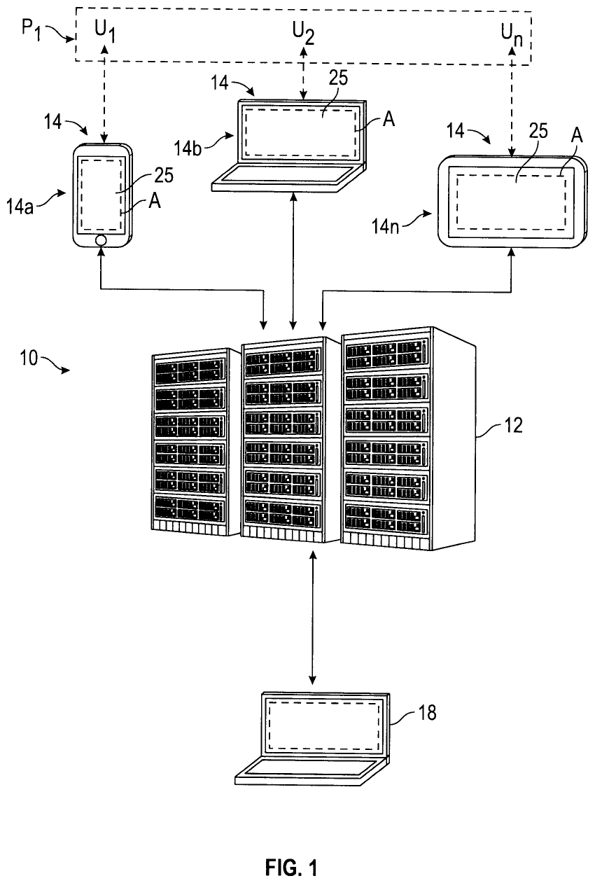

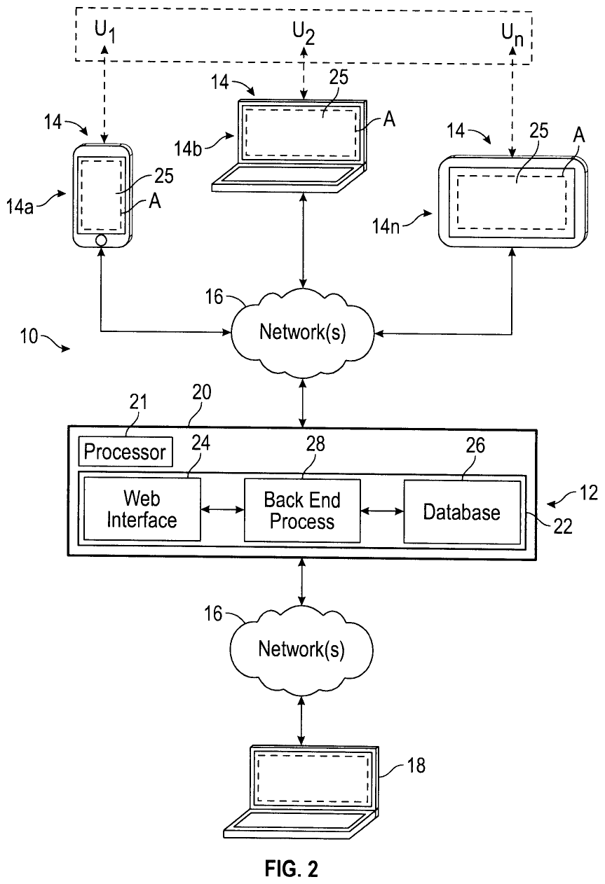

FIGS. 1 and 2 illustrate an example embodiment of a system 10 for pairing individuals with each other and/or training an algorithm to pair individuals with each other based on third party input. In the illustrated embodiment, the system 10 includes a central server 12 and one or more user terminals 14 operated by one or more users U₁, U₂ . . . Uₙ. The central server 12 is configured to wirelessly communicate with each of the user terminals 14 via a network 16 to present the users terminals 14 with paired first profiles P(L) and second profiles P(R) and to train a pairing algorithm and/or perform other functions based on input from the user terminals 14 in response. The system 10 can also include one or more administrative terminal 18 that can be used by an administrator to adjust data flow, for example, to speed up or slow down the system 10 or perform intelligent data deletions as needed.

Each of the plurality of user terminals 14 can be, for example, a cellular phone, a tablet, a personal computer, or another personal electronic device. Here, the plurality of user terminals 14 includes a first user terminal 14a, a second user terminal 14b, and an nth user terminal 14n. Each user terminal 14 can be controlled by a distinct user U₁, U₂ . . . Uₙ (e.g., a first user U₁ controls the first user terminal 14a, a second user U₂ controls the second user terminal 14b, and an nth user Uₙ controls the nth user terminal 14n). As used herein, each of the users U₁, U₂ . . . Uₙ can also be referred to generally as a user U. Using the system 10, any user U can log into the system 10 and provide feedback regarding paired first profiles P(L) and second profiles P(R). A user U can be an individual who has created a profile that will be paired with other profiles by the system 10, or a user U can be an individual who solely reviews and approves or disapproves of pairs created by the system 10.

Each of the administrative terminals 18 can be, for example, a cellular phone, a tablet, a personal computer, or another personal electronic device. Here, only one administrative terminal 18 is shown for simplicity. The administrative terminal 18 can be used by an administrative user to alter rules used by the central server 12. As discussed in more detail below, the administrative user can make various adjustments and/or selectively reset portions of the system 10 at any time.

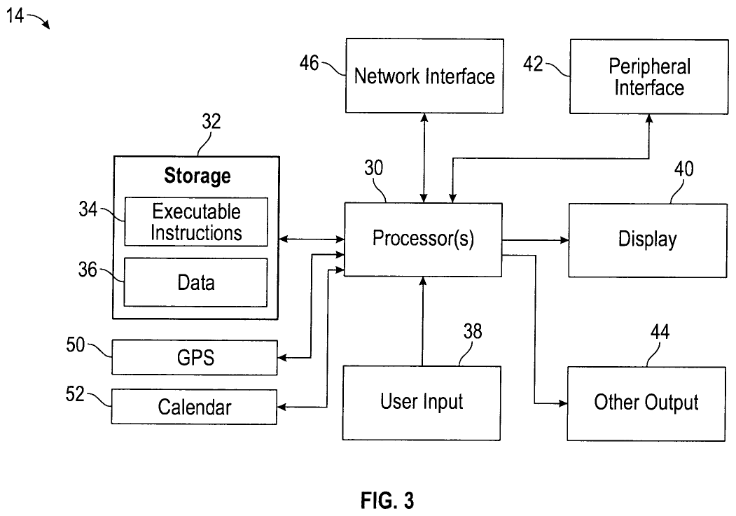

FIG. 3 illustrates a representative diagram of an example embodiment of a user terminal 14 or an administrative terminal 18. As illustrated, a user terminal 14 or an administrative terminal 18 can include a terminal processor 30 and a terminal memory 32. The terminal processor 30 is configured to execute instructions programmed into and/or stored by the terminal memory 32. The instructions can be received from and/or periodically updated by the web interface 24 of the central server 12 in accordance with the methods discussed herein. As described in more detail below, many of the functions described herein can be stored as instructions in the terminal memory 32 and executed by the terminal processor 30.

In an embodiment, the terminal processor 30 can comprise one or more of a microprocessor, microcontroller, digital signal processor, co-processor or the like or combinations thereof capable of executing stored instructions 34 and operating upon stored data 36, wherein the instructions 34 and/or stored data 36 are stored by the terminal memory 32. The terminal memory 32 can comprise one or more devices such as volatile or nonvolatile memory, for example, random access memory (RAM) or read only memory (ROM). Further, the terminal memory 32 can be embodied in a variety of forms, such as a hard drive, optical disc drive, etc. In an embodiment, many of the processing techniques described herein are implemented as a combination of executable instructions 34 and data 36 stored within the terminal memory 32.

As illustrated, each of the plurality of user terminals 14 or administrative terminals 18 includes a user input device 38, a display 40, a peripheral interface 42, an output device 44, and a network interface 46 in communication with the terminal processor 30. The user input device 38 can include any mechanism for providing a user input to the terminal processor 30, for example, a keyboard, a mouse, a touch screen, a microphone and/or suitable voice recognition application, or another input mechanism. The display 40 can include any conventional display mechanism such as a cathode ray tube (CRT), a flat panel display, a touch screen, or another display mechanism. Thus, as can be understood, the user input device 38 and/or the display 40 and/or any other suitable element can be considered a GUI 25. The peripheral interface 42 can include the hardware, firmware, and/or other software necessary for communication with various peripheral devices, such as media drives (e.g., magnetic disk or optical disk drives), other processing devices, or another input source used as described herein. Likewise, the other output device 44 can optionally include similar media drive mechanisms, other processing devices or other output destinations capable of providing information to a user of the user terminal 14, such as speakers, LEDs, tactile outputs, etc. The network interface 46 can comprise hardware, firmware and/or software that allows the terminal processor 30 to communicate with other devices via wired or wireless networks 16, whether local or wide area, private or public. For example, such networks 16 can include the World Wide Web or Internet, or private enterprise networks, or the like.

In various embodiments discussed herein, the user terminal 14 can include one or more user data device configured to track and/or periodically gather user data 36 regarding the user U of the user terminal 14. Such a user data device can include, for example, a global positioning system (“GPS”) device 50, a digital calendar 52, and/or another terminal-specific device which tracks movements and/or data usage by the user U of the user terminal 14. In an embodiment, the GPS device 50 and/or the digital calendar 52 can be integrally included with the user terminal 14. Alternatively, the user terminal 14 can be placed in wireless communication with the GPS device 50 and/or the digital calendar 52 so as to enable operation as described herein. In an embodiment, the user data gathered from a user data device such as a GPS device 50, a digital calendar 52, and/or another terminal-specific device can be stored as data 36 within the terminal memory 32 and accessed by the central server 12 as needed.

The GPS device 50 can be used, for example, to record past or present data regarding the physical location of the user terminal 14, which can be used to determine the physical locations of the user U who typically uses the user terminal 14. In an embodiment, an application A downloaded to the user terminal 14 is configured to automatically access the user U's past or present locations without the user U having to separately navigate and open up the GPS device 50 to retrieve the data. In an embodiment, the user U of a user terminal 14 can be required to enable access to the GPS device 50 for the system 10 to determine and/or utilize the user U's past or present locations. In an embodiment, relevant data from the GPS device 50 can be stored as data 36 within the terminal memory 32 and accessed by the central server 12 as needed.

The digital calendar 52 can be, for example, a calendar application which is downloaded to the user terminal 14 and/or stores the user U's past, present, and/or future commitments. In an embodiment, the digital calendar 52 can be associated with the user U's email. The digital calendar 52 can be stored on the terminal memory 32, or can be stored on an alternative memory device and accessed by the user terminal 14 via wireless communication over the network 16. In an embodiment, relevant data from the digital calendar 52 can be stored as data 36 within the terminal memory 32 and accessed by the central server 12 as needed. In an embodiment, an application A downloaded to the user terminal 14 is configured to automatically access the user U's digital calendar 52 without the user U having to separately navigate and open up the digital calendar 52 to retrieve the calendar data.

While the user terminal 14 and administrative terminal 18 have been described as one form for implementing the techniques described herein, those having ordinary skill in the art will appreciate from this disclosure that other functionally equivalent techniques can be employed. For example, some or all of the functionality implemented via executable instructions can also be implemented using firmware and/or hardware devices such as application specific integrated circuits (ASICs), programmable logic arrays, state machines, etc. Further, other implementations of the user terminal 14 or administrative terminal 18 can include a greater or lesser numbers of components than those illustrated. Further still, although a single user terminal 14 or administrative terminal is illustrated in FIG. 3, it should be understood from this disclosure that a combination of such devices can be configured to operate in conjunction (for example, using known networking techniques) to implement the methods described herein.

Referring again to FIGS. 1 and 2, the central server 12 can comprise one or more server computers, database servers and/or other types of computing devices, particularly in connection with, for example, the implementation of websites and/or enterprise software. The central server 12 includes a central controller 20. The central controller 20 includes a central processor 21 and a central memory 22. The central processor 21 is configured to execute instructions programmed into and/or stored by the central memory 22. In an embodiment, the central processor 21 can comprise one or more of a microprocessor, microcontroller, digital signal processor, co-processor or the like or combinations thereof capable of executing stored instructions and operating upon stored data, wherein the instructions and/or data are stored by the central memory 22. The central memory 22 can comprise one or more devices such as volatile or nonvolatile memory, for example, random access memory (RAM) or read only memory (ROM). Further, the central memory 22 can be embodied in a variety of forms, such as a hard drive, optical disc drive, etc. As described in more detail below, the steps of the methods described herein can be stored as instructions in the central memory 22 and executed by the central processor 21.

In the illustrated embodiment, the central memory 22 can include a web interface 24, a database 26, and back end processing instructions 28. Here, the web interface 24, the database 26, and the back end processing instructions 28 can be controlled or accessed by the central processor 21 implementing appropriate software programs by executing the back end processing instructions 28 or other instructions programmed into and/or stored by the central memory 22.

The web interface 24 provides a graphical user interface (“GUI”) 25 that can be displayed on a terminal 14 for a user U, and manages the transfer of data received from and sent to the GUI 25 on the terminal 14. For example, the GUI 25 can be employed by a user U to create a profile, to view and approve or disapprove profile pairs of other users U created by the system 10, and to provide such data to the central server 12, as described in more detail below. In an embodiment, each user terminal 14 can include an application A comprising software downloaded to and executed by the terminal 14 to provide the GUI 25 and to manage communications with the central server 12. The application A can be downloaded to the user terminal 14 from the central server 12 or from some other source such as an application distribution platform. The application A is configured to access the user terminal 14's GPS device 50 and digital calendar 52 without the user U having to separately open up and navigate separate applications to retrieve the data needed for the central server 12 to execute the methods discussed herein.

The database 26 can store user profiles and user profile pairs, as well as data retrieved from the user terminal 14 and/or data created by the central server 12 to match user profiles. In an embodiment, the database 26 can comprise a database management system (DBMS) operating on one or more suitable database server computers. In an embodiment, the database 26 can include a plurality of sub-databases. Storage and use of the database 26 is discussed in more detail below.

The back end processing instructions 28 can be operatively coupled to both the web interface 24 and the database 26, and can be programmed into and/or stored by the central memory 22 and implemented by the central processor 21. In an embodiment, the back end processing instructions 28 can be executed by the central processor 21 to direct operations of the central server 12 as described below in further detail. For example, the central processor 21, executing the back end processing instructions 28, can manage the receipt, storage, maintenance, etc. of relevant data. Additionally, the central processor 21, executing the back end processing instructions 28, can develop the database 26 and/or a pairing algorithm PA used to implement the system 10, as discussed in more detail below.

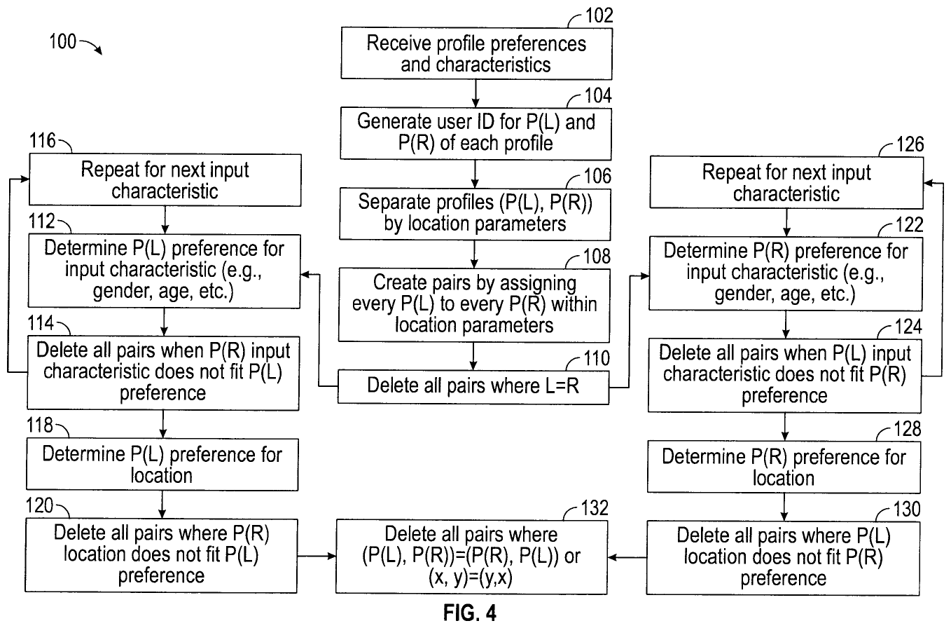

FIG. 4 illustrates an example embodiment of a method 100 for creating, updating and/or resetting the database 26 as needed in accordance with the present disclosure. The method 100 can be implemented by the system 10 described herein. In an embodiment, one or more of the steps of the method 100 can be executed by the central controller 20 using instructions stored on the central memory 22 and executed by the central processor 21. In an embodiment, one or more of the steps of the method 100 can be stored as instructions on the terminal memory 32 and executed by the terminal processor 30. It should be understood by those of ordinary skill in the art from this disclosure that some of the steps described herein can be reordered or omitted without departing from the spirit or scope of method 100.

At step 102, the central controller 20 receives inputs from the application A of a user terminal 14 of a first user U that wishes to create a profile that will pair the first user U with one or more second user U that has also created a profile. The inputs can include input characteristics of the first user U (e.g., gender, age, interests, etc.) and input preferences of the first user U (e.g., preferences for gender, age, interests, etc. in a second user U). The application A can access the GPS device 50 of the user terminal 14 and use the GPS device 50 to set the location of the first user U. The application A can also access the digital calendar 52 of the user terminal 14 and use the digital calendar 52 to set the availability of the first user U.

In the illustrated embodiment, the system 10 creates two profiles for each user U being paired, which are referred to herein as a profile P(L) and a profile P(R). As discussed in more detail below with respect to FIG. 4, when a matchmaking user U views a potential pair, the profile P(L) can be a profile for one of the potential pair shown on one side of the matchmaking user U's GUI 25 during the method 200 (e.g., a left profile), and the profile P(R) can be a profile for the other of the potential pair shown on the other side of the matchmaking user U's GUI 25 during the method 200 (e.g., a right profile).

In an embodiment, the profile P(L) and the profile P(R) can be created by the application A at the user terminal 14 and transmitted to the central server 12 to be stored in the database 26. Alternatively, the profile P(L) and the profile P(R) can be created by the central controller 20 after receiving the input characteristics and input preferences via the application A.

In an embodiment, when the database 26 is first created and/or reset, the system 10 at step 102 creates or resets the database 26 using inputs from a plurality of applications A of user terminals 14 of users U. Then, when additional users U are added to the database 26, the system 10 individually adds those additional users to the database 26 as needed. If the database 26 is reset, the system 10 is configured to rebuild the database 26 using the original users U and the additional users U who were added later. In this way, the system 10 enables controlled resets and rebuilds of the database 26 or any sub-databases as needed.

At step 104, the central controller 20 assigns a unique user identification (ID) for the profile P(L) and the profile P(R) of each user U. More specifically, the central controller 20 sets the profile P(L) and the profile P(R) to have the same user ID. In an embodiment, the application A being used at the user terminal 14 assigns the user ID so that the user ID can be set without access to the central server 12. In an embodiment, the application A determines the location of the user terminal 14 using the GPS device 50 and sets the user ID to have a particular identifier (e.g., prefix, suffix) based on the location parameters determined from the GPS device 50. This way, the system 10 can create the user ID without having access to the central server 12 or needing to otherwise request the user ID from somewhere outside the user terminal 14. In an embodiment, the user ID designates both a location and one or more sublocation by one or more letters, numbers and/or symbols, for example, in the prefix or suffix of the user ID.

In an embodiment, at step 106, the central controller 20 stores the profile P(L) and the profile P(R) for each user U in the database 26 based on location. In a further embodiment, the central controller 20 stores the profile P(L) and the profile P(R) in one of a plurality of sub-databases of the database 26 based on location. In an embodiment, the central controller 20 automatically stores the profile P(L) and the profile P(R) using the particular identifier set by the application A at the user terminal 14.

At step 108, the central controller 20 creates pairs of profiles P(L) and profiles P(R) within the database 26. In an embodiment, for example when the database 26 is created and/or reset, the central controller 20 creates pairs by assigning every profile P(L) to every profile P(R) that is within the database 26 or within each sub-database. More specifically, the central controller 20 creates pairs by assigning every profile P(L) to every profile P(R). In an embodiment, the central controller 20 at regular intervals pairs all profiles P(L) with all profiles P(R). In another embodiment, for example when a new first user U creates a profile, the central controller 20 creates pairs by assigning the first user's profile P(L) to all of the profiles P(R), and by assigning the first user's profile P(R) to all profiles P(L).

At step 110, the central controller 20 deletes pairs where the user ID of the profile P(L) is the same as the user ID of the profile P(R). More specifically, the central controller 20 deletes all pairs within each database 26 or sub-database where the user ID of the profile P(L) is the same as the user ID of the profile P(R). By deleting these profile pairs at this point in the method 100, the central controller 20 frees up additional memory space in the database 26 and reduces processing resources used in the following steps and/or for adding additional users U.

At step 112, the central controller 20 determines the profile P(L) preference for a first input characteristic (e.g., a first of gender, age, interest, etc.), and at step 114, the central controller 20 deletes all pairs where the matched profile P(R) has a first input characteristic that does not fit the profile P(L) preference. At step 116, the central controller 20 returns to step 112 to determine the profile P(L) preference for a second input characteristic (e.g., a second of gender, age, interests, etc.) and then repeats step 114 and deletes all pairs where the matched profile P(R) has a second input characteristic that does not fit the profile P(L) preference. The central controller 20 continues to perform steps 112, 114 and 116 until it has deleted all pairs where the matched profile P(R) input characteristic does not fit the profile P(L) preference. By deleting these additional pairs at this point in the method 100, the central controller 20 frees up additional memory space in the database 26 and reduces processing resources for additional users U to be added.

In an embodiment, the user U setting up the profile can narrow the location parameters beyond what has been assigned based on application A using the GPS device 50 at the user terminal 14. If the user U has done so, at step 118 the central controller 20 determines the profile P(L) preference for location, and at step 120 the central controller 20 deletes all pairs where the matched profile P(R) does not have a location fitting the profile P(L) preference for location. In an embodiment, the central controller 20 uses the particular identifier identifying location and sublocation as set by the application A at the user terminal 14 at step 104 to delete pairs where the matched profile P(R) does not have the same identifier.

At step 122, the central controller 20 determines the profile P(R) preference for a first input characteristic (e.g., a first of gender, age, interest, etc.), and at step 124, the central controller 20 deletes all pairs where the matched profile P(L) has a first input characteristic that does not fit the profile P(R) preference. At step 126, the central controller 20 returns to step 122 to determine the profile P(R) preference for a second input characteristic (e.g., a second of gender, age, interests, etc.) and then repeats step 124 and deletes all pairs where the matched profile P(L) has a second input characteristic that does not fit the profile P(L) preference. The central controller 20 continues to perform steps 122, 124 and 126 until it has deleted all pairs where the matched profile P(L) input characteristic does not fit the profile P(R) preference. By deleting these additional pairs at this point in the method 100, the central controller 20 frees up additional memory space in the database 26 and reduces processing resources for additional users U to be added.

In an embodiment, the user U setting up the profile can narrow the location parameters beyond what has been assigned based on application A using the GPS device 50 at the user terminal 14. If the user has done so, at step 128 the central controller 20 determines the profile P(R) preference for location, and at step 130 the central controller 20 deletes all pairs where the matched profile P(L) does not have a location fitting the profile P(R) preference for location. In an embodiment, the central controller 20 uses the particular identifier identifying location and sublocation as set by the application A at the user terminal 14 at step 104 to delete pairs where the matched profile P(L) does not have the same identifier.

At step 132, the central controller 20 deletes all pairs where (P(L), P(R))=(P(R), P(L)) or (x, y)=(y, x). This ensures that users U are not paired with themselves. By deleting these additional pairs at this point in the method 100, the central controller 20 frees up additional memory space in the database 26 and reduces processing resources for additional users U to be added.

Thus, at the end of step 132, the central controller 20 has set up or reset a sub-database or database 26 containing pairs of profiles P(L) and P(R), while minimizing memory storage, which can be used in an improved method 200 for matching individuals with each other and/or training an algorithm to match individuals with each other based on third party input. One advantage of setting up the sub-databases as described herein is that an administrator can reset just a particular sub-database without resetting the entire database 26.

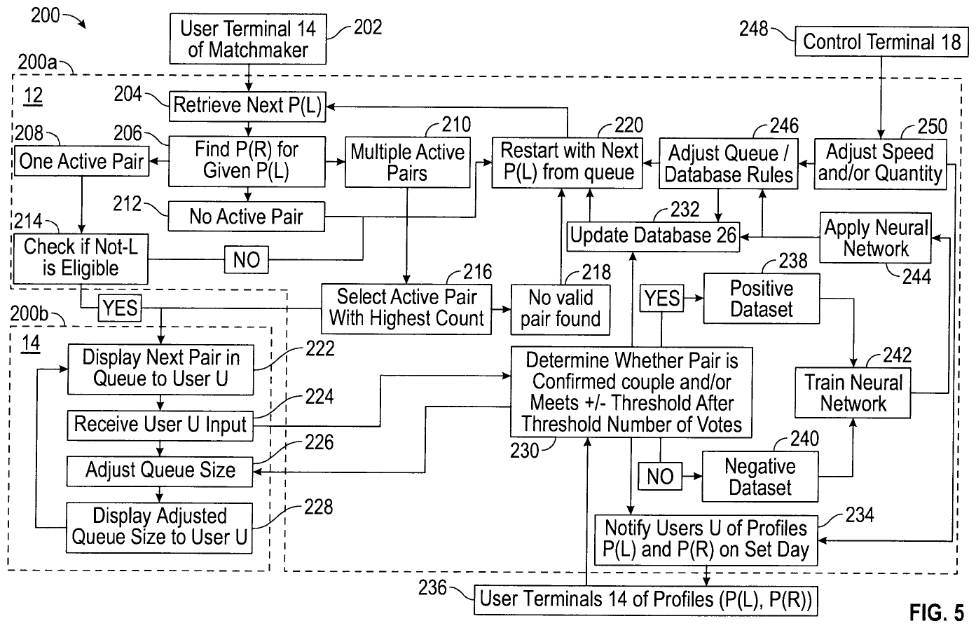

FIG. 5 illustrates an example embodiment of a method 200 for pairing individuals with each other based on third party input and/or training an algorithm to pair individuals with each other based on third party input in accordance with the present disclosure. As seen in FIG. 4, the method 200 combines a method 200a performed by the central controller 20 at the central server 12 using the database 26 with a machine learning pairing algorithm PA trained and implemented by the central controller 20 at the central server 12, and a method 200b which uses an application A providing a GUI 25 at a user terminal 14 to receive third party input to create matches.

The method 200 can be implemented by the system 10 described herein using one or more database 26 or sub-database created and updated using the method 100 described herein. In an embodiment, one or more of the steps of the method 200 can be executed by the central controller 20 using instructions stored on the central memory 22 and executed by the central processor 21. In an embodiment, one or more of the steps of the method 200 can be stored as instructions on the terminal memory 32 and executed by the terminal processor 30. In an embodiment, the steps of the method 200a are performed at the central server 12, while the steps of the method 200b are performed at the user terminal 14. It should be understood by those of ordinary skill in the art from this disclosure that some of the steps described herein can be reordered or omitted without departing from the spirit or scope of method 200.

At step 202, a user U uses a user terminal 14 to log into the application A. The user U can be a user U who has set up a profile and been added to the database 26 in accordance with the method 100 discussed herein. The user U can also be a user U without a profile. The user U can thus be either a third party without a profile or a third party that will view pairs of profiles of other users U. The user U can log into the application A using a username, password, fingerprint, or other identifying and security parameters known in the art. In an embodiment, the user U also makes a selection within the application A to trigger the application A to begin displaying pairs of profiles for the user U to approve or disapprove.

At step 204, the central controller 20 accesses the database 26 and retrieves a profile P(L). The P(L) can be a random selection. Alternatively, the P(L) can be the next P(L) in a queue. In an embodiment, the queue can be personal to the user U who logged in at step 202.

At step 206, the central controller 20 searches for a profile P(R) from the database that is an active pair with the retrieved the profile P(L). In an embodiment, an active pair is a pair that has already received at least one positive or negative input from another user U during the method 200b discussed below. In the illustrated embodiment, the retrieved P(L) can be actively paired with one profile P(R) (step 208), with multiple profiles P(R) (step 210), or with no profile P(R) (step 212). If the profile P(L) is not actively paired with any profile P(R) at step 212, then the method proceeds to step 220 and another profile P(L) is selected.

If the profile P(L) is actively paired with only one profile P(R) at step 208, then the method proceeds to step 214. At step 214, the central controller 20 checks whether the active pair of profiles P(L) and P(R) are still an eligible pair. For example, either of the profile P(L) or the profile P(R) may have adjusted respective input characteristics and/or input characteristic preferences since being paired, which may have changed whether the profile P(L) and the profile P(R) are still an eligible pair. If the profile P(L) and the profile P(R) are still an eligible pair, then the central controller 20 proceeds to the method 200b using the pair. If the profile P(L) and the profile P(R) are no longer an eligible pair, then the central controller 20 proceeds to step 220 to retrieve the next profile P(L) and repeat the process.

If the profile P(L) is actively paired with multiple profiles P(R) at step 210, then the method proceeds to step 216 where the active pair with the highest count is chosen. In an embodiment, the highest count means the most inputs (e.g., positive or negative) from users U using the method 200b discussed below. In another embodiment, the highest count can be determined by one of the following equations:

$$Count = ARN / CAR ; or \qquad ( Equation 1 )$$

$$Count = ( CAR / ARN ) - CAR . \qquad ( Equation 2 )$$

In Equations 1 and 2, CAR is the total number of provided positive (+) inputs for a pair, and ARN is the number of remaining positive (+) inputs needed for an active pair to meet the threshold at step 230, as discussed in more detail below. ARN can be dynamic threshold depending on the number of inputs and the time frame of the process. In an embodiment, an administrator can log into a control terminal 18 and adjust the threshold as needed or desired, which can change the count, as discussed in more detail below. For example, the administrator can reduce or increase ARN resulting in faster or slower matches on certain days of the week or during specific time periods.

In an embodiment, the pair of profiles P(L), P(R) is a match when ARN<0%, and the pair of profiles P(L), P(R) is a not a match when ARN>100%. When 0%<ARN<100%, the pair of profiles P(L), P(R) is still pending.

In an embodiment, an active pair of profiles P(L), P(R) is deleted from the database 26 of the central memory 22 once the threshold becomes unachievable. Deleting profiles in this manner can allow for the memory to include only highly counted profiles and matches. This way, the memory space is optimized and the deleted pair of profiles P(L), P(R) can be replaced with a new pair of profiles P(L), P(R), so that the central controller 20 can continue generating new pairs of profiles P(L), P(R) without requiring additional memory space at the central memory 22.

At step 218, if there is no valid pair including the P(L), then the central controller 20 accesses the database 26 and restarts with a next profile P(L), and then repeat steps 204, 206, 208, 210, 212, 214, 216, 218, 220 as needed until a pair with one user U's profile P(L) and another user U's profile P(R) can be placed in a queue and/or presented to the user U at step 222. In an embodiment, the central controller 20 repeats steps 204, 206, 208, 210, 212, 214, 216, 218, 220 to build up a queue of pairs (P(L) and P(R)) that can be presented to the user U at the user terminal 14. In an embodiment, the central controller 20 can regularly send the user terminal 14 data packets with a plurality of pairs, and the user terminal 14, within the application A, can build up a queue of pairs for consecutive presentation to the user U using the application A at step 222.

At step 222, the application A presents the user U with an active profile pair including a profile P(L) and a corresponding profile P(R). More specifically, the application A shows the profile P(L) and profile P(R) side by side on the GUI 25. The profile P(L) can be a profile for one user U of the potential pair shown on one side of the matchmaking user U's GUI 25 (e.g., a left profile), and the profile P(R) can be a profile for the other user U of the potential pair shown on the other side of the matchmaking user U's GUI 25 (e.g., a right profile). Those of ordinary skill in the art will recognize from this disclosure that there are also other ways of presenting potential pairs on the GUI 25. In an embodiment, the user U must approve or disapprove of the displayed pair before being allowed to move on to the next pair. This way, the system 10 is able to gather enough data to approve or delete pairs as needed. Additional embodiments can allow multiple users to approve or delete in combination. For example, in an embodiment, two users each having a profile P(R) in conjunction (such as P(R1) and P(L2)) can coordinate together so that sets of combined P(L) results (such as P(L1) and P(L2)) can overlap and be reviewed concurrently. In another embodiment, third parties can provide input on the viability of the combined pair of P(R1) and P(L1) with the combined pair of P(R2) and P(L2).

At step 224, the application A receives user input from the user U. The user U can provide positive (+) input regarding the pair of profiles (P(L), P(R)) shown, or the user U can provide negative (−) input regarding the pair of profiles (P(L), P(R)) shown. In an embodiment, the user U is instructed to provide positive (+) input if they believe that the pair of profiles (P(L), P(R)) would be a compatible pair or otherwise a good match, and the user U is instructed to provide negative (−) input if they believe that the pair of profiles (P(L), P(R)) would not be a compatible pair or otherwise not be a good match.

At step 226, the central controller 20 has the ability to increase or decrease the size of the queue shown to the user U. In an embodiment, the central controller 20 has a plurality of profiles in the queue for each user U, only some of which are shown to the user U. The queue size displayed to the user U via the GUI 25 can change depending on input provided by the user.

In an embodiment, the central controller 20 increases or decreases the queue size displayed to the user U based on input from other users U. For example, the queue size can increase or decrease based on whether the user U is making positive or negative inputs that are aligned with other users U regarding the pair of profiles (P(L), P(R)). In an embodiment: (i) the queue size increases when the user U makes a positive input for a pair of profiles (P(L), P(R)) that has also received a threshold number or percentage of positive inputs from other users U; (ii) the queue size decreases when the user U makes a positive input for a pair of profiles (P(L), P(R)) that has also received a threshold number or percentage of negative inputs from other users U; (iii) the queue size increases when the user U makes a negative input for a pair of profiles (P(L), P(R)) that has also received a threshold number or percentage of negative inputs from other users U; and/or (iv) the queue size decreases when the user U makes a negative input for a pair of profiles (P(L), P(R)) that has also received a threshold number or percentage of positive inputs from other users U.

In another embodiment, the central controller 20 increases or decreases the queue size displayed for the user U based on feedback by the pair of users U corresponding to the pair of profiles (P(L), P(R)). For example, if a matched-up pair confirm that they have become a couple or otherwise were a good match, the central controller 20 can increase the queue size displayed the user U. Conversely, if a matched-up pair confirm that they have not become a couple or otherwise were not a good match, the central controller 20 can decrease the queue size displayed the user U.

By increasing or decreasing the queue size of the user U, the system 10 is able to reward users U who make good matches or attempt to make good matches, and the system 10 can reduce the pairs shown to users U who do not make good matches or do not attempt to make good matches. This can cause a user U making bad matches and seeing a decreasing queue to spend more time or try to make better matches as their queue size decreases. This can also disincentivize users U from intentionally making bad matches, or even work those users U out of the system 10.

In an embodiment, the application A can occasionally display a pair of profiles (P(L), P(R)) which has already been confirmed as a couple or a good match, as well as occasionally display a pair of profiles (P(L), P(R)) that already been confirmed as not a couple or not a good match. The application A and/or central controller 20 can use the inputs from this already confirmed pair to evaluate the decisions made by the user U at step 224 and then adjust the queue size accordingly at step 226.

At step 228, the application A displays the adjusted size of the queue for the user U. This can inform the user U that they are making good or bad pairs. In an embodiment, the application A displays a circle which increases in size when a new pair is added or as the queue size increases and decreases in size as the queue size decreases to provide visual feedback to the user U.

The application A can then return to step 222 and display the next pair of profiles (P(L), P(R)) in the queue. The application A can continue to perform steps 222, 224, 226 and 228 as long as there are still more pairs of profiles (P(L), P(R)) in the user U's queue.

At step 230, the central controller 20 keeps track of the positive and negative inputs provided by users U for a pair of profiles (P(L), P(R)) stored in the database 26. More specifically, the central controller 20 tracks one or more of (i) total positive selections, (ii) total negative selections, (iii) total overall selections, (iv) percentage of positive selections, and/or (v) percentage of negative selections. In an embodiment, the central controller 20 determines a pair to be compatible when an overall threshold of positive selections are received. In an embodiment, the central controller 20 determines a pair to be a noncompatible couple when an overall threshold of negative selections are received. In an embodiment, the central controller 20 determines a pair to be a compatible couple when an overall percentage of positive selections are received after a threshold number of selections are made. In an embodiment, the central controller 20 determines a pair to be a noncompatible couple when an overall percentage of negative selections are received after a threshold number of selections are made. In an embodiment, the central controller 20 uses one or both of Equation 1 and Equation 2 discussed herein to determine whether the threshold is met or has become unachievable.

At step 232, the central controller 20 updates the database 26. In an embodiment, the central controller 20 updates the database 26 to delete any pair of profiles (P(L), P(R)) that have been determined to be noncompatible at step 230. This way, the central server 12 does not use unnecessary memory storage space and processing resources on noncompatible pairs which can be replaced by new pairs as new users U create profiles or adjust preferences or characteristics. In another embodiment, the central controller 20 updates the database to mark the pair of profiles (P(L), P(R)) as noncompatible, so that a user U who thereafter provides negative input regarding the profile (P(L), P(R)) receives an increase in queue size, and/or so that a user U who thereafter provides positive input regarding the profile (P(L), P(R)) receives a decrease in queue size. In an embodiment, the central controller 20 updates the database to mark the pair of profiles (P(L), P(R)) as compatible, so that a user U who thereafter provides positive input regarding the profile (P(L), P(R)) receives an increase in queue size, and/or so that a user U who thereafter provides negative input regarding the profile (P(L), P(R)) receives a decrease in queue size.

At step 234, the central controller 20 sends notifications to the users U of any pair of profiles (P(L), P(R)) that have been determined to be compatible at step 230. The central controller 20 can notify those users U by sending a message to each of their user terminals 14 via the application A. The central controller 20 can also place those users U in contact with each other so that they can arrange a meeting (e.g., virtual meeting through the application A or meeting in person). In one embodiment, the central controller 20 sends notifications to those users U immediately after the central controller 20 has determined them to be compatible at step 230. In another embodiment, which is discussed in more detail below, the central controller 20 waits until a later time or day to send out notifications to a plurality of pairs of profiles (P(L), P(R)) that have been determined to be compatible.

At step 236, the central controller 20 receives feedback from the users U of the compatible pair of profiles (P(L), P(R)). Those users U can indicate that they have become a couple or otherwise were a good match, or they can indicate that they have not become a couple or otherwise were not a good match. The central controller 20 can then use this data, for example, (i) to increase or decrease the queue size of other users U who provided input regarding the pair of profiles (P(L), P(R)) at step 226, (ii) to update the database 26 at step 232, and/or (iii) to create positive or negative datasets at steps 238 and 240 to train the pairing algorithm PA used by the central controller 20 to create future pairs of profiles (P(L), P(R)).

At step 238, the central controller 20 creates positive training datasets for updating a machine learning pairing algorithm PA. The machine learning pairing algorithm PA can be a neural network. In an embodiment, the central controller 20 creates a positive training dataset when an overall threshold number of positive selections are received from users U at step 224 as determined at step 230. In an embodiment, the central controller 20 creates a positive training dataset when an overall percentage of positive selections are received from users U at step 224 as determined at step 230. In an embodiment, the central controller 20 creates a positive training dataset when the users U of a pair of profiles (P(L), P(R)) indicate that they have become a couple or otherwise were a good match at step 236. In an embodiment, the central controller 20 uses one or both of Equation 1 and Equation 2 discussed herein to determine whether the threshold is met.

In an embodiment, the positive training dataset includes a matrix of data representative of the input characteristics and input preferences for each of the pair of profiles (P(L), P(R)). The central controller 20 can create the positive training data set by transforming the input characteristics and input preferences for each of the pair of profiles (P(L), P(R)) into the matrix of representative values. When a profile P(L) or a profile P(R) does not have any data for an input characteristic or an input preference, the central controller 20 can use an empty or zero entry in the matrix. Although the specific structure of the data matrix can vary in terms of rows or columns, the central controller 20 uses the same matrix data format for all positive training datasets and negative training datasets.

At step 240, the central controller 20 creates negative training datasets for updating the pairing algorithm PA. In an embodiment, the central controller 20 creates a negative training dataset when an overall threshold number of negative selections are received from users U at step 124 as determined at step 230. In another embodiment, the central controller 20 creates a negative training dataset when an overall percentage of negative selections are received from users U at step 124 as determined at step 230. In an embodiment, the central controller 20 creates a negative training dataset when the users U of a pair of profiles (P(L), P(R)) indicate that they have not become a couple or otherwise were not a good match at step 236. In an embodiment, the central controller 20 uses one or both of Equation 1 and Equation 2 discussed herein to determine whether the threshold has become unachievable, for example, when it no longer becomes possible to receive enough positive inputs based on an overall limit of total inputs for the pair.

In an embodiment, the negative training dataset includes a matrix of data representative of the input characteristics and input preferences for each of the pair of profiles (P(L), P(R)). The negative training datasets have the same matrix structure as the positive datasets. The central controller 20 can create the negative training data set by transforming the input characteristics and input preferences for each of the pair of profiles (P(L), P(R)) into the matrix of representative values. When a profile P(L) or a profile P(R) does not have any data for an input characteristic or an input preference, the central controller 20 can use an empty or zero entry in the matrix. Although the specific structure of the data matrix can vary in terms of rows or columns, the central controller 20 uses the same matrix data format for all positive training datasets and negative training datasets.

At step 242, the central controller 20 trains the machine learning pairing algorithm (neural network). The central controller 20 trains the neural network using the positive training datasets created at step 238 as positive examples of the inputs that the pairing algorithm PA should indicate is a compatible pair, and the central controller 20 trains the neural network using the negative training datasets created at step 240 as negative examples of the inputs that the pairing algorithm PA should indicate is a compatible pair.

At step 244, the updated neural network has been updated to create pairs more likely to receive positive input. More specifically, the central controller 20 creates data matrices from the database 26 that have the same data structure as the training sets and inputs them into the neural network. When the neural network determines the datasets to be likely to receive positive input, the central controller 20 creates those pairs in the database 26 and/or queue and/or moves up those pairs in the queue. When the neural network determines the datasets to be likely to receive negative input, the central controller 20 deletes those pairs from the database 26 and/or the queue and/or moves down those pairs in the queue. Thus, the central controller 20 can continuously process pairs as the neural network is trained and adjust the database accordingly.

As the neural network is continuously updated, the method 100 of creating and updating the database 26 will not need to match every P(L) to every P(R), which will reduce processing resources and memory space in the database 26 relative to the overall number of users U. Another advantage is that if the neural network becomes unusable or is not creating enough compatible matches, the database 26 can be reset and repopulated by restarting the method 100 of FIG. 3 with the users U that have active profiles.

At step 246, the neural network can be used to update rules for one or both of the database 26 and/or the queue of pairs of profiles (P(L), P(R)). In an embodiment, the central controller 20 updates the rules to delete pairs of profiles (P(L), P(R)) from the database 26 which are determined by the neural network to be unlikely to be compatible. In another embodiment, the central controller 20 updates the rules to adjust how pairs of profiles (P(L), P(R)) are listed in the queue based whether the neural network determines them to be likely to be compatible. The central controller 20 can then use the updated rules, for example, to adjust the database 26 at step 232 and/or adjust the queue at step 220.

At step 248, an administrator can log into a control terminal 18 and make adjustments to one or more steps of the method 200. In an embodiment, the administrator chooses to increase or decrease the speed notifying compatible matches. For example, the administrator can set certain days of the week to notify users U when their profile has been determined to be in a compatible pair of profiles (P(L), P(R)). The administrator can also increase or decrease the average size, top limit or bottom limit of the queues to facilitate more or less pairs of profiles (P(L), P(R)) being seen by users U during the method 200b. In an embodiment, the administrator can adjust the size of the database 26 by instructing the central controller 20 delete a number or percentage of the lowest ranked pairs of profiles (P(L), P(R)) as determined by the neural network. In an embodiment, the administrator can adjust the threshold(s) used at step 230.

At step 250, the central controller 20 receives the administrator's input from the control terminal 18. In an embodiment, when the administrator chooses to increase or decrease the speed notifying compatible matches, the central controller 20 proceeds to step 234 and adjusts how often or at what times the notifications are sent to users U of pairs of profiles (P(L), P(R)) determined to be compatible. One reason an administrator may adjust the time is to push out notifications on a day or at a time when users U are more likely to connect with each other or meet in person. This throttling feature can be used as a promotional or advertising feature to encourage users to meet at a certain restaurant or other location on a certain day as well as a certain time. The central controller 20 can throttle the notifications automatically using data based on the user profile such as membership status, local date and time, the user's advertising profile, and a current advertising campaign parameters.

In another embodiment, when at step 250 the administrator chooses to increase or decrease the average size, top limit or bottom limit of the queues to facilitate more or less pairs of profiles (P(L), P(R)) being seen, or when the administrator chooses to adjust the size of the sub-databases or overall database 26, the central controller 20 proceeds to step 246 to adjust the rules. The central controller 20 can then use the updated rules, for example, to adjust the database 26 at step 232 and/or adjust the queue at step 220.

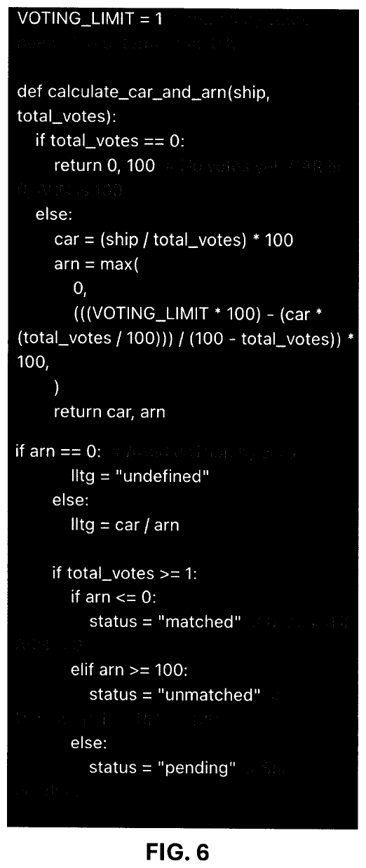

FIG. 6 illustrates an example code snippet for a central controller 20 at step 250 using input from control terminal 18 at step 248 to adjust the speed at which notifications are provided to users in accordance with an embodiment of the present disclosure.

In an embodiment, the method 200 can be performed for a plurality of different regions and/or sub databases, so that the neural network will be trained differently for different regions. This way, the neural network will be more accurate for each segment that it is trained for by accounting for regional variables and opinions.

The central server 12 filters the data before being sent to the user terminal 14. Filtering at this point allows for higher efficiency, security, control, consistency of data, and scaling. Tracking the filtering done is also more efficient when the central server 12 filters the data.

The systems and methods described herein can be used for various types of matches, for example, to determine matches when hiring for new jobs or when forming teams to perform a task. Those of ordinary skill in the art will recognize from this disclosure that there are a variety of ways of utilizing the systems and methods described herein.

The systems and methods described herein are advantageous for matching individuals with each other and/or training an algorithm to match individuals with each other based on third party input. The disclosed systems and methods are particularly advantageous in reducing processing resources and memory storage through intelligent purges of data. It should be understood that various changes and modifications to the methods described herein will be apparent to those skilled in the art and can be made without diminishing the intended advantages.

### General Interpretation of Terms

In understanding the scope of the present invention, the term “comprising” and its derivatives, as used herein, are intended to be open ended terms that specify the presence of the stated features, elements, components, groups, and/or steps, but do not exclude the presence of other unstated features, elements, components, groups, integers and/or steps. The foregoing also applies to words having similar meanings such as the terms, “including”, “having” and their derivatives. Also, the terms “part,” “section,” or “element” when used in the singular can have the dual meaning of a single part or a plurality of parts. Accordingly, these terms, as utilized to describe the present invention should be interpreted relative to a connecting device.

The term “configured” as used herein to describe a component, section or part of a device includes hardware and/or software that is constructed and/or programmed to carry out the desired function.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A computer-implemented method of training a neural network to create compatible pairs of profiles using third party input, the method comprising:
collecting third party input regarding whether a plurality of pairs of profiles displayed to a plurality of third party users are compatible or not compatible;
creating a first training set comprising input data and preferences relating to each of the matched pair of profiles when the matched pair of profiles are determined to be a positive match;
training the neural network in a first stage using the first training set;
creating a second training set comprising input data and preferences relating to each of the matched pair of profiles when the matched pair of profiles are determined to be a negative match; and
training the neural network in a second stage using the second training set.

2. The method of claim 1, comprising
determining the matched pair of profiles to be the positive match when an overall threshold number of positive selections are received from the plurality of third party users.

3. The method of claim 1, comprising
determining the matched pair of profiles to be the positive match when an overall percentage of positive selections are received from users.

4. The method of claim 1, comprising
determining the matched pair of profiles to be the negative match when an overall threshold number of negative selections are received from the plurality of third party users.

5. The method of claim 1, comprising
determining the matched pair of profiles to be the negative match when an overall percentage of negative selections are received from users.

6. The method of claim 1, comprising
using the neural network to delete pairs of profiles from a database.

7. The method of claim 1, comprising
using the neural network to adjust a queue of pairs of profiles.

8. A method of conserving memory resources for a non-pair user when building a database for pairing a first individual user with a second individual user to create a profile pair, the method comprising:
collecting third party input data from the non-pair user regarding whether a plurality of profile pairs displayed to a plurality of third party users are compatible or not compatible;
auditing and preventing duplicate third party input data from the non-pair user;
coding the third party input data from the non-pair user based on preference data of profiles when the third party data determines that a profile pair is a positive match;
coding separately the third party input data based on preference data of profiles when the third party data determines that a profile pair is a negative match;
deleting third party input data based on whether the profile pair is coded as a negative match for similar non-pair user profiles; and
updating through a central computer the positive match information for each profile pair.

9. The method of claim 8, comprising
assigning a weighted value to the non-pair user profile based on past determinations of profile pairs.

10. The method of claim 8, comprising
assigning a weighted value to the profile pair based on past determinations of that same profile pair.

11. The method of claim 8, comprising
assigning a weighted value to the profile pair based on past determinations of each of the data input related to the first individual user profile.

12. The method of claim 8, comprising
assigning a weighted value to the profile pair based on past determinations of each of the data input related to the second individual user profile.

13. A system for matching a first user individual with a second user individual into a profile pair, the system comprising:
a first user terminal configured to receive a plurality of inputs from a first user regarding input characteristic preferences;
a second user terminal configured to receive a plurality of inputs from a second user regarding input characteristic preferences;
a central server comprising a central controller controlling at least one memory, at least one processor, and at least one storage device,
the at least one memory storing a database of a plurality of profile pairs and a pairing algorithm for creating the pairs of profiles,
the central controller causing the processor to execute instructions stored on the memory so as to: (i) create a profile pair using the plurality of inputs from the first user regarding the input characteristic preferences and the plurality of inputs from the second user regarding the input characteristics; (ii) receive positive or negative selections regarding the profile pair from a plurality of third party users; (iii) train the pairing algorithm using the positive or negative selections; and (iv) use the trained pairing algorithm to reduce the plurality of pairs in the database.

14. The system of claim 13, comprising:
a third user terminal configured to receive a plurality of inputs from a third user related to the first user regarding input characteristic preferences;
a fourth user terminal configured to receive a plurality of inputs from a fourth user related to the second user regarding input characteristic preferences; and
the central controller further executing instructions to combine and display a plurality of profile pairs.

15. The system of claim 13, comprising
the central controller further executing instructions to assign a weighted value to the profile pair based on past determinations of that same profile pair from a user.

16. The system of claim 15, comprising
the central controller further executing instructions to:
measure the assigned weighted value to the profile pair based on past determinations of each of the data input related to the first individual user profile; and
update the selection of the second individual user profile based on the history of positive selections of the second individual user profile.

17. The system of claim 15, comprising
the central controller further executing instructions to:
measure the assigned weighted value to the profile pair based on past determinations of each of the data input related to the second individual user profile; and
update the selection of the first individual user profile based on the history of positive selections of the second individual user profile.

18. The system of claim 14, comprising:
the central controller further executing instructions to weigh the input characteristic preferences of both the first individual user profile and the third individual user profile.

19. The system of claim 14, comprising:
the central controller further executing instructions to weigh the input characteristic preferences of both the first individual user profile and the third individual user profile.

20. The system of claim 13, comprising:
the central controller further executing instructions to adjust the speed of notifications to a first individual user profile.
